(19) United States
(12) Patent Application Publication
(10) Pub. No.: US 2017/0016525 A1
(43) Pub. Date: Jan. 19, 2017

(54) GROUNDED DAMPER

(71) Applicant: BorgWarner Inc., Auburn Hills, MI (US)

(72) Inventors: Wesley L. Shaw, Rochester Hills, MI (US); Matthias Burmeister, Dossenheim (DE)

(21) Appl. No.: 14/801,282

(22) Filed: Jul. 16, 2015

(51) Int. Cl. F16H 57/00; F16H 57/10; F16F 15/10; F16H 1/28

(52) U.S. Cl. CPC F16H 57/0006; F16H 1/28; F16H 57/10; F16F 15/10; F16H 2057/0012; F16H 2057/087

(57) ABSTRACT

A product may include a first torque transfer element and a second torque transfer element that may be connected through a gear set. A housing may be provided wherein a damper may be connected between the gear set and the housing.

### TECHNICAL FIELD

The field to which the disclosure generally relates includes torque transmission devices and more particularly, includes damping in torque transmission devices.

### BACKGROUND

Torque transmission may involve rotating elements leading from a power source to a load. One such application may involve an internal combustion engine that generates power, which may be delivered to one or more drive wheels through a variable gear ratio transmission.

### SUMMARY OF ILLUSTRATIVE VARIATIONS

According to a number of illustrative variations, a product may include a first torque transfer element and a second torque transfer element that may be connected through a gear set. A housing may be provided wherein a damper may be connected between the gear set and the housing.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective sectioned view of a product according to a number of variations.

FIG. 2 is a partial assembly view of a product according to a number of variations.

FIG. 3 is a schematic illustration of a product according to a number of variations.

FIG. 4 is a schematic illustration of a product according to a number of variations.

FIG. 5 is a schematic illustration of a product according to a number of variations.

FIG. 6 is a diagrammatic illustration of a system according to a number of variations.

### DETAILED DESCRIPTION OF ILLUSTRATIVE VARIATIONS

The following description of the variations is merely illustrative in nature and is in no way intended to limit the scope of the invention, its application, or uses.

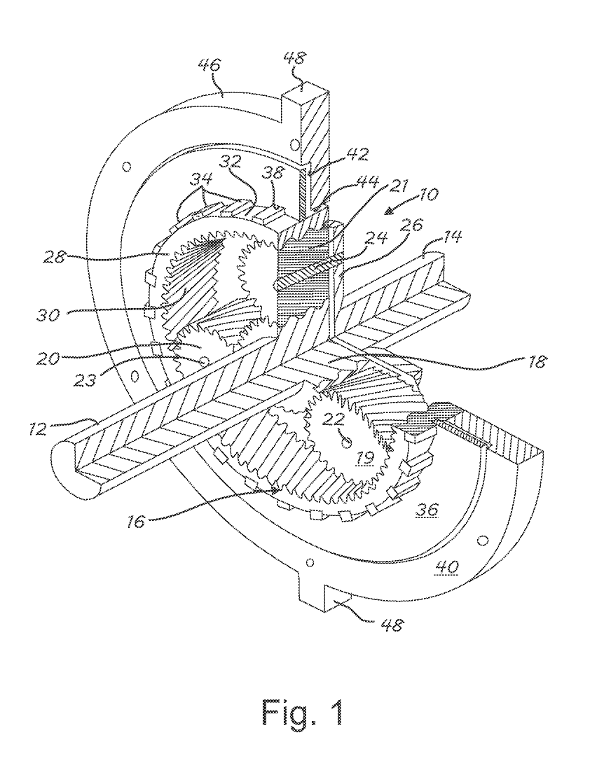

In a number of variations as illustrated in FIG. 1, a product 10, which may be used in a power transmission path, may include a torque transfer element 12 for input and a torque transfer element 14 for output. It should be appreciated that the product 10 is equally operable with the torque transfer element 14 providing input and the torque transfer element 12 providing output. The product 10 may include a gear set 16, which may be a planetary gear set and may be a compound planetary gear set, or may be another gear set arrangement. The gear set 16 may include a sun gear 18 that may be directly connected to the torque transfer element 12, and the two may be configured to rotate together in a fixed relationship. The sun gear 18 may be directly engaged with a number of planet gears 19-21. The sun gear 18 and the planet gears 19-21 may include teeth that mesh together so that rotation of the sun gear 18 results in counter-rotation of each of the planet gears 19-21. Each of the planet gears 19-21 may rotate about a center pin 22-24. The pins 22-24 may be fixed to a carrier 26 which may maintain the positions of the planet gears 19-21 and may rotate in response to rotation of the sun gear 18. The carrier 26 may be directly connected in a fixed relationship to the torque transfer element 14 so that rotation of the carrier 26 results in rotation of the torque transfer element 14. The planet gears 19-21 may be surrounded by an annulus gear 28 that may include internal teeth 30 that may mesh with the teeth of the planet gears 19-21. Rotation of the planet gears 19-21 may result in a rotational effort being applied to the annulus gear 28, depending on the operating conditions of the torque transfer elements 12 and 14.

The annulus gear 28 may include an outer perimeter 32 with a series of radially outward projecting lugs 34. A clutch disk 36, which may be a friction disk, may include an inner perimeter with a series of slots 38 which may receive the lugs 34 so that the clutch disk 36 may be rotationally fixed on the annulus gear 28. In a number of variations a backing plate 40 may be positioned adjacent the clutch disk 36 and may extend around the annulus gear 28. The backing plate 40 may include an annular groove 42 that may be cut or otherwise formed in the side facing the clutch disk 36 from the inner perimeter 44. The groove 42 may be shaped to receive the clutch disk 36. The backing plate may include an outer perimeter 46 from which a number of posts 48 may extend radially outward.

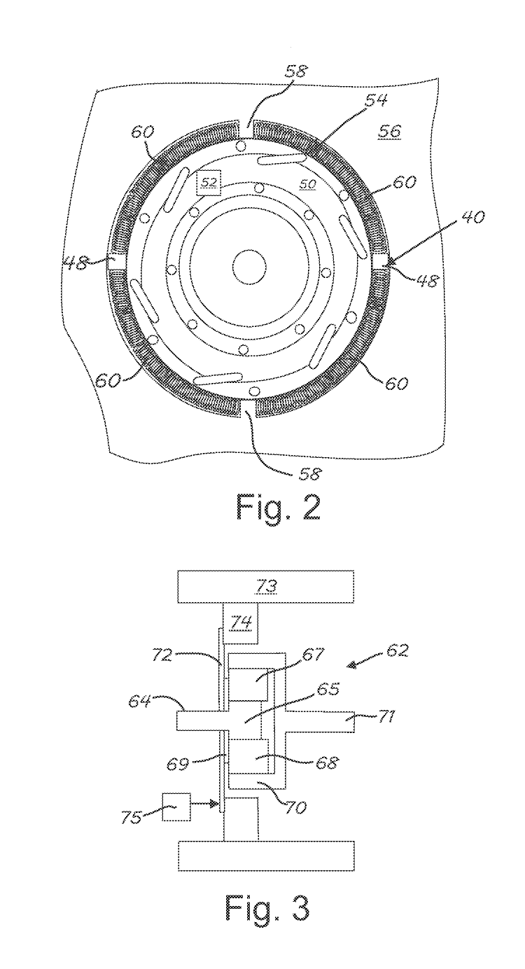

With additional reference to FIG. 2, in a number of variations a pressure plate 50 may be positioned adjacent the clutch disk 36. An actuator, or number of actuators 52 may be provided to force the pressure plate 50 against the clutch disk 36. This may compress the clutch disk 36 between the pressure plate 50 and the backing plate 40 so that rotational force may be communicated from the annulus gear 28, through the clutch disk 36 to the backing plate 40. In the event of rotation of the annulus gear 28 and actuation of the pressure plate 50, rotational effort may be translated to the backing plate 40 with or without slip. In a number of variations, the backing plate 40 may be positioned within an opening 54 that may be circular and that may be defined by a housing 56. The housing 56 may be a case, block, support, plate, structural member, or another element or part thereof. The housing 56 may be relatively non-rotating compared to the torque transfer elements 12 and 14 and functionally may operate as ground. The housing 56 may include a land 58 or a number of lands 58 that may extend radially inward in the opening 54. The backing plate 40 may be positioned in the opening 54 so that the post or posts 48 may extend toward the housing 56 and the land or lands 58 may extend toward the backing plate 40. Rotational effort applied to the backing plate 40 may tend to drive each post 48 toward or away from the adjacent land 58.

In a number of variations a damper 60, or a number of dampers 60 may be positioned between each adjacent post 48 and land 58. In the variation illustrated in FIG. 2 four dampers 60 are shown, although the number may vary depending on the type of damper used and the application. Each damper 60 may be an element resiliently resistive in extension and/or compression, and may be actively variable to adjust for operating conditions in real time. Each damper 60 may be mechanical, fluid, electrical, magnetic, or material based, or may be a combination thereof, or of another type as one skilled in the art may deem suitable for the given application. Each damper 60 may be connected or otherwise engaged between the backing plate 40 and the housing 56.

In a number of variations, operation of the product 10 may involve rotational input to the torque transfer element 12 which may rotate the sun gear 18. Rotation of the sun gear 18 may effect rotation of the planet gears 19-21, which may result in rotation of the carrier 26 and the torque transfer element 14. In a number of variations, operation of the product 10 may involve rotational input to the torque transfer element 14 which may rotate the carrier 26. Rotation of the carrier 26 may effect rotation of the planet gears 19-21, which may result in rotation of the sun gear 18 and the torque transfer element 12. In a number of variations, rotation of the planet gears 19-21 may result in rotational force on the annulus gear 36 and the engaged clutch disk 36. The clutch may be closed by actuation of the pressure plate 50 through an actuator 52. In a number of variations, the clutch may remain engaged/closed to provide continuous damping and may be disengaged/opened when desired, or a fixed connection between the gear set and the damper 60 may be provided through the annulus gear 28. Dynamic excitation, which may include phenomenon such as vibration or torque oscillation, may be experienced by the gear set 16. Oscillations may be passed to the damper 60, which may temporarily store the energy during a torque peak, and may release energy during a torque valley. By returning the stored energy during reduced torque, isolation may be provided by the grounded damper 60, recovering energy without losses through heat dissipation.

With reference to FIG. 3, a number of variations may involve a product 62 that may include a torque transfer element 64 connected to a gear set at gear 65. The gear 65 may mesh with gears 67 and 68, which may be disposed on a carrier 69. The gears 67 and 68 may mesh with a gear 70 that may have internal teeth, and which may be connected to a torque transfer element 71. In a number of variations, the gear 70 may be cup shaped to facilitated engagement with the gears 67 and 68, and with the torque transfer element 71, which may be a shaft. The gears 67 and 68 may be planet gears and another number may be provided. In a number of variations the shape of the gear 70 may be suitable for connection to the adjacent component in the torque transfer path, so that the gear 70 may also serve as the torque transfer element. Input to the gear set may be provided through either of the torque transfer elements 64, 71.

In a number of variations a clutch member 72 may be connected to the carrier 69, or may be integrally formed as one component therewith, which may serve both the functions of containing the gears 67, 68 and as a clutch component. The clutch member 72 may freely rotate around the torque transfer element 64. The clutch member 72 may be a friction disk or may be another clutch component to selectively transfer rotation between the carrier 69 and the housing 73 through a damper 74. In a number of variations additional clutch components may be employed in the transfer of torque from the carrier 69 to the damper 74, such as those described in relation to FIGS. 1 and 2. An actuator 75 may provide a mechanism to engage the clutch member 72 to dissipate energy through the damper 74. The actuator may operate such as by moving a pressure plate toward a backing plate with the clutch member 72 in between. The damper 74 may be engaged between the clutch member 72 and the housing 73 directly, or indirectly such as through a backing plate. The damper 74 may be connected to the housing 73 so that while it may dampen the rotating elements, it may do so by reciprocating, at least in part, to dissipate energy without rotating with the rotating elements.

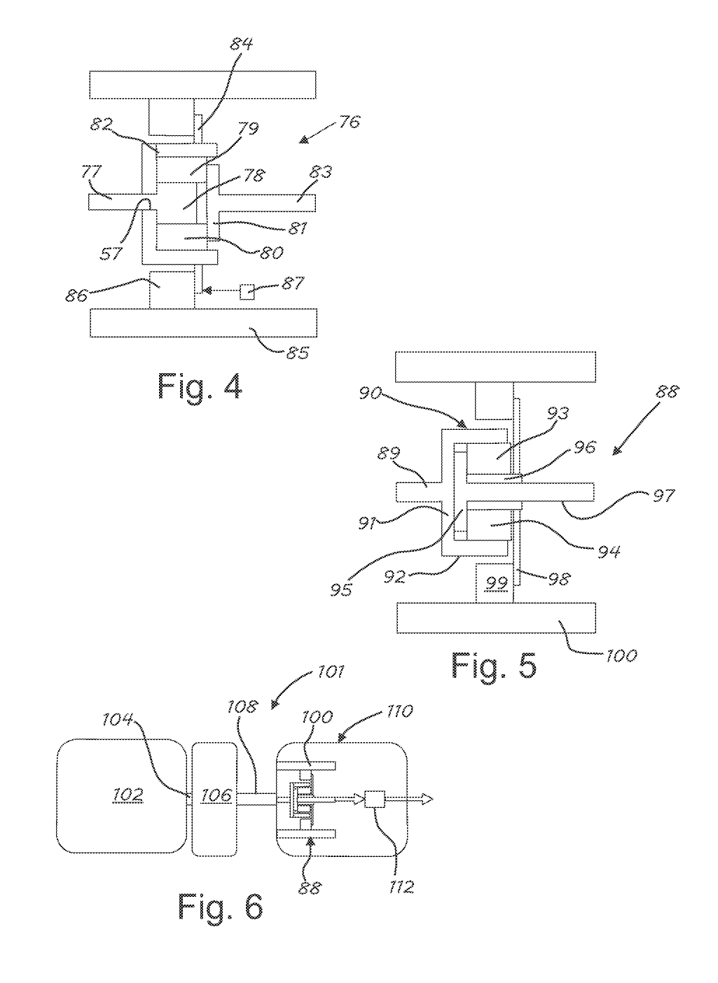

In a number of variations illustrated by FIG. 4, a product 76 may include a torque transfer element 77 connected to a gear set at gear 78. The gear 78 may mesh with gears 79 and 80, which may be disposed on a carrier 81. The carrier 81 may serve as or may be connected with a torque transfer element 83. The gears 79 and 80 may mesh with a gear 82 that may have internal teeth. The gears 79 and 80 may be planet gears and another number may be provided. The gear 82 may be cup shaped and may include an opening 57 through which the torque transfer element 77 may freely extend to connect with the gear 78. Rotation of the gear 78 may result in rotation of the gears 79 and 80, which may result in rotational force being applied to the gear 82. The gear 82 may be an annulus gear of a planetary gear set and may include or may be connected to a clutch member 84. Input to the gear set may be provided through either of the torque transfer elements 77, 83.

In a number of variations the clutch member 84 may be a friction disk or may be another clutch component to selectively transfer rotation between the gear 82 and the housing 85 through a damper 86. In a number of variations additional clutch components may be employed in the transfer of torque from the gear 82 to the damper 86. For example, a backing plate may be engaged with the damper 86 and a pressure plate may force the clutch member 84 against the backing plate. An actuator 87 may provide a mechanism to engage the clutch member, such as by moving a pressure plate toward a backing plate with the clutch member 84 in between. The actuator 87 may be mechanical, fluid power, electrical or otherwise operated. Engagement of the clutch member 84 may transmit torque from the rotating components to the housing 85 to dissipate energy through the damper 86. The damper 86 may be engaged between the clutch member 84 and the housing 85 directly, or indirectly such as through a backing plate. The damper 86 may be connected to the housing 85 so that while it may dampen the rotating elements, it may do so by reciprocating, at least in part, to dissipate energy rather than rotating with the rotating elements. In a number of variations, the clutch may remain engaged/closed to provide continuous damping and may be disengaged/opened when desired, or a fixed connection between the gear set and the damper may be provided through the gear 82.

With reference to FIG. 5, a number of variations may include a product 88 that may include a torque transfer element 89 connected to a gear set at a gear 90. The gear 90 may be an annulus gear of a planetary gear set and may be cup shaped. The gear 90 may include a circular base section 91 and a ring section 92. The ring section 92 may include internal teeth and the base section 91 may be connected to the torque transfer element 89. The gear 90 may mesh with gears 93 and 94, which may be disposed on a carrier 95. The carrier 95 may be disposed adjacent the base section 91 and within the gear 90. The gears 93 and 94 may mesh with a gear 96. The gears 93 and 94 may be planet gears and another number may be provided. The gear 96 may be a sun gear and may be associated with a torque transfer element 97 onto which the gear 96 may be rotably mounted. The torque transfer element 97 may be a shaft that may extend through the gear 96 and may be connected to the carrier 95 to rotate therewith. Input to the gear set may be provided through either of the torque transfer elements 89, 97.

In a number of variations the gear 96 may be connected to or formed with a fixing element 98 which may be a disk shaped component that may extend radially outward from the gear 96 past the ring section 92 of the gear 90. A damper 99 may be connected between the fixing element 98 and a housing 100. As a result, the gear 96 may be fixed to the housing 100 through the damper 99 so that it may reciprocate through compression and extension of the damper 99. The gear 96 may not rotate or may rotate only as permitted by reciprocation of the damper 99. The fixing element 98 may be shaped similar to the backing plate 40 of FIGS. 1 and 2 so that the damper may be engaged between a post of the fixing element 98 and a land on the housing 100, or may take another shape.

In a number of variations input through the torque transfer element 89 may rotate the gear 90, which may rotate the meshing gears 93 and 94. Rotation of the gears 93 and 94 may cause rotation of the carrier 95 and the connected torque transfer element 97. Dynamic excitation encountered by the gear set may be transferred to the gear 96 and the fixing element 98 for dissipating energy through the damper 99. The dampers 74, 86 and 99 may be of any type as described in relation to FIGS. 1 and 2.

In a number of variations as illustrated in FIG. 6, a diagrammatic representation is provided of an environment within which the products 10, 62, 76 and 88 may be used in a system 101. A power source 102, which may be an engine, a motor, or another driving or driven apparatus may provide torque to an input torque transfer element 104, which may be a shaft, a fixed connection, a plate, or other structure appropriate for the application. The input torque transfer element 104 may, in turn, deliver torque to a coupling device 106, which may be a releasable clutch such as found in a vehicle with a manual transmission, or may be a torque converter such as found in a vehicle with an automatic transmission, or may be another coupling device suitable for the application. In a number of variations the power source 102 may be connected directly to the coupling device 106 without an intervening torque transfer element. The coupling device 106 may be connected through a torque transfer element 108 to a variable transmission unit 110. The torque transfer element 108 may be a shaft, a fixed connection, a plate, or other structure appropriate for the application. In a number of variations the coupling device 106 may be directly connected to the transmission unit 110 without an intervening torque transfer element.

In a number of variations the transmission unit 110 may include the product 88 as described in relation to FIG. 5, along with a known transmission 112 having any desired power flow. The transmission 112 may be manually or automatically shifted, or a combination thereof, may be a continuously variable transmission, or may be another type. In a number of variations the transmission unit 110 may include the product 10, 62, or 76 instead of the product 88. In a number of variations the product 88 may be reversed so that the input and output sides are exchanged. The housing 100 may be a part of the case of the transmission unit 110. While the product 88 is described within the system 101 in reference to FIG. 6, it may be used in other environments where torque is transferred and dynamic excitation damping and/or suppression is desired.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product that may include a first torque transfer element and a second torque transfer element connected through a gear set. A housing may be provided with a damper connected between the gear set and the housing.

Variation 2 may include the product according to variation 1 wherein the gear set may be a planetary gear set with a sun gear, a planet gear and an annulus gear. The sun gear may be engaged with the annulus gear through the planet gear.

Variation 3 may include the product according to variation 1 or 2 and may include a first clutch member connected to the gearset, and a second clutch member engageable with the first clutch member. The damper may be connected between the clutch member and the housing.

Variation 4 may include the product according to any of variations 1 through 3 wherein the housing may be a transmission case.

Variation 5 may include the product according to any of variations 1 through 3 wherein the housing may be an engine block.

Variation 6 may include the product according to variation 3 wherein the first clutch member may be a friction disk.

Variation 7 may include the product according to variation 3 or 6 wherein the second clutch member may be a backing plate.

Variation 8 may include the product according to variation 7 wherein the backing plate may include an outer perimeter with a post extending radially outward from the outer perimeter. The post may engage the damper.

Variation 9 may include the product according to variation 7 or 8 and may include a pressure plate that may be positioned on an opposite side of the friction plate from the backing plate. The pressure plate may compress the friction plate against the backing plate.

Variation 10 may involve a product that may include an engine with an output torque transfer element and a transmission having variable gears and an input torque transfer element. A gear set may connect the output torque transfer element with the input torque transfer element. A housing may be included that may not rotate. A damper may be engaged between the gear set and the housing.

Variation 11 may include the product according to variation 10 wherein the gear set may be a planetary gear set that may have a sun gear, a planet gear and an annulus gear. The sun gear may be engaged with the annulus gear through the planet gear.

Variation 12 may include the product according to variation 11 wherein the annulus gear may include an outer perimeter that may have one or more lugs.

Variation 13 may include the product according to any of variations 10 through 12 and may include a first clutch member that may be connected to the gear set. A second clutch member may be included that may be engageable with the first clutch member. The damper may be engaged between the second clutch member and the housing.

Variation 14 may include the product according to variation 13 wherein the first clutch member may be a friction disk, and the second clutch member may be a backing plate.

Variation 15 may include the product according to variation 14 wherein the backing plate may include an outer perimeter that may have a post extending radially outward from the outer perimeter. The post may engage the damper.

Variation 16 may include the product according to variation 14 or 15 and may include a pressure plate that may be positioned on an opposite side of the friction plate from the backing plate. The pressure plate may compress the friction plate against the backing plate.

Variation 17 may include the product according to any of variations 14 through 16 wherein the backing plate may include a groove and the friction disk may be engageable in the groove.

Variation 18 may include the product according to any of variations 14 through 17 wherein the housing may define a circular opening within which the backing plate may be positioned.

Variation 19 may include the product according to variation 18 wherein the backing plate may include a post and the housing may include a land that may extend into the circular opening. The damper may be engaged between the post and the land.

Variation 20 may involve a product that may include a torque transfer element that rotates. A gear set may be driven by the torque transfer element. The gear set may include a sun gear, a planet gear and an annulus gear. The sun gear may be engaged with the annulus gear through the planet gear. A housing may surround the gear set. A damper may be carried by the housing and may be engageable with the gear set at one of: the sun gear; the planet gear; or the annulus gear. The gear set may be grounded to the housing through the damper.

1. A product comprising:
a first torque transfer element;
a second torque transfer element;
a gear set, the first and second torque transfer elements connected through the gear set;
a housing; and
a damper connected between the gear set and the housing, and
a first clutch member connected to the gear set, and a second clutch member engageable with the first clutch member, wherein the damper is connected between the second clutch member and the housing, and is resilient in at least one of compression or extension between the second clutch member and the housing.

2. The product according to claim 1 wherein the gear set is a planetary gear set with a sun gear, a planet gear and an annulus gear, the sun gear engaged with the annulus gear through the planet gear.

3. (canceled)

4. The product according to claim 1 wherein energy passed to the damper from at least one of the second clutch member or the housing, is temporarily stored in the damper during a torque peak, and released from the damper during a torque valley.

5. The product according to claim 1 wherein the housing includes an opening within which the second clutch member is disposed, with a post extending from the housing, the post engaging the damper.

6. The product according to claim 1 wherein the first clutch member is a friction disk that includes grooves, and the gear set includes lugs fixed in the grooves so that the first clutch member is rotationally fixed to the gear set.

7. The product according to claim 6 wherein the second clutch member is a backing plate that includes an outer perimeter with a post extending radially outward from the outer perimeter, the post engaging the damper.

8. A product comprising:
a first torque transfer element;
a second torque transfer element;
a gear set, the first and second torque transfer elements connected through the gear set;
a housing;
a damper connected between the gear set and the housing, and
a first clutch member connected to the gear set, and a second clutch member engageable with the first clutch member, wherein the damper is connected between the second clutch member and the housing, wherein the first clutch member is a friction disk, wherein the second clutch member is a backing plate, and wherein the backing plate includes an outer perimeter with a post extending radially outward from the outer perimeter, the post engaging the damper.

9. The product according to claim 7 further comprising a pressure plate positioned on an opposite side of the friction disk from the backing plate, wherein the pressure plate compresses the friction disk against the backing plate.

10. A product comprising:
an engine with an output torque transfer element;
a transmission having variable gears and an input torque transfer element;
a gear set connecting the output torque transfer element with the input torque transfer element;
a housing that does not rotate; and
a damper engaged between the gear set and the housing, the damper resilient in at least one of compression or extension between the gear set and the housing.

11. The product according to claim 10 wherein the gear set is a planetary gear set with a sun gear, a planet gear and an annulus gear, the sun gear engaged with the annulus gear through the planet gear.

12. The product according to claim 11 comprising a friction disk disposed between the housing and the gear set, wherein the friction disk includes grooves, wherein the annulus gear includes an outer perimeter with one or more lugs fixed in the grooves so that the friction disc is rotationally fixed to the gear set.

13. The product according to claim 10 further comprising a first clutch member connected to the gear set, and a second clutch member that is engageable with the first clutch member, wherein the damper is engaged between the second clutch member and the housing.

14. The product according to claim 13 wherein the first clutch member is a friction disk, and the second clutch member is a backing plate.

15. The product according to claim 14 wherein the backing plate includes an outer perimeter with a post extending radially outward from the outer perimeter, the post engaging the damper.

16. The product according to claim 14 further comprising a pressure plate positioned on an opposite side of the friction plate from the backing plate, wherein the pressure plate compresses the friction plate against the backing plate.

17. The product according to claim 14 wherein the backing plate includes a groove and the friction disk is engageable in the groove.

18. The product according to claim 14 wherein the housing defines a circular opening within which the backing plate is positioned.

19. The product according to claim 18 wherein the backing plate includes a post and the housing includes a land extending into the circular opening and the damper is engaged between the post and the land.

20. A product comprising:
a torque transfer element that rotates;
a gear set driven by the torque transfer element, wherein the gear set includes a sun gear, a planet gear and an annulus gear, the sun gear engaged with the annulus gear through the planet gear;
a housing surrounding the gear set;
a damper carried by the housing and engageable with the gear set at one of: the sun gear; the planet gear; or the annulus gear, wherein the gear set is grounded to the housing through the damper, and
a first clutch member connected to the gear set, and a second clutch member engageable with the first clutch member, wherein the damper is connected directly between the second clutch member and the housing, and the damper is resilient in at least one of compression or extension between the gear set and the housing.

21. The product according to claim 20 wherein the damper contacts both the second clutch member and the housing, and wherein energy passed to the damper from at least one of the gear set or the housing, is temporarily stored in the damper during a torque peak, and released from the damper during a torque valley.

22. The product according to claim 20 wherein the second clutch member includes an outer perimeter with a post extending radially outward from the outer perimeter, the post engaging the damper.

23. The product according to claim 20 wherein the first clutch member is a friction disk and the second clutch member is a backing plate engageable by the friction disk to transfer torque, and wherein the backing plate includes an outer perimeter, and the housing defines an opening within which the backing plate is disposed defining an annular shaped space between the outer perimeter and the housing within which the damper is contained.
